(19) United States
(12) Patent Application Publication
(10) Pub. No.: US 2024/0230881 A1
(43) Pub. Date: Jul. 11, 2024

(54) HANDHELD FINE-GRAINED RFID LOCALIZATION SYSTEM WITH COMPLEX-CONTROLLED POLARIZATION

(71) Applicant: Massachusetts Institute of Technology, Cambridge, MA (US)

(72) Inventors: Fadel ADIB, Cambridge, MA (US); Laura Noelle DODDS, Cambridge, MA (US); Aline EID, Ann Arbor, MI (US); Isaac S. PERPER, Medford, MA (US)

(73) Assignee: Massachusetts Institute of Technology, Cambridge, MA (US)

(21) Appl. No.: 18/505,355

(22) Filed: Nov. 9, 2023

Related U.S. Application Data
(60) Provisional application No. 63/479,447, filed on Jan. 11, 2023.

(51) Int. Cl. G01S 13/75; G01S 13/86; H01Q 21/24

(52) U.S. Cl. CPC G01S 13/75; G01S 13/867; H01Q 21/24

(57) ABSTRACT

A handheld system radio frequency identification (RFID) system for fine-grained RFID localization of an RFID target. Also disclosed is a mechanism for localizing RFID targets at all orientations through software-controlled polarization of two LP antennas. The system may detect an RFID target using a generated circularly polarized (CP) RF signal and accurately localize the RFID target using a generated linearly polarized (LP) signal. The disclosed systems and techniques discover and localize RFID concurrently and regardless of RFID target orientation.

### CROSS-REFERENCE TO RELATED APPLICATIONS

This application claims priority to U.S. Provisional Patent Application No. 63/479,447, filed on Jan. 11, 2023, the entire content of which is hereby incorporated by reference herein.

### FEDERAL STATEMENT

This invention was made with government support under CNS1844280 and IIP-2044711 awarded by the National Science Foundation. The government has certain rights in the invention.

### FIELD OF TECHNOLOGY

The described technology generally relates to systems and techniques for radio frequency identification (RFID) of an RFID target, and more particularly to a handheld, fine-grained RFID system for discovery and localization of an RFID target.

### BACKGROUND

The use of radio frequency (RF) signals to identify a location of a target (also sometimes referred to herein as an “RFID target” or more simply a “tag”) is referred to as radio frequency identification (RFID) localization. Systems which perform RFID localization are referred to as RFID systems (sometimes referred to as “RFID scanners” or more simply “scanners” or “RFID readers” or more simply “readers”).

RFID systems and localization techniques have attracted much attention from the mobile and sensor computing community due to numerous applications spanning retail, manufacturing, warehousing, entertainment, and more.

Most existing RFID systems fall into two categories: a first category includes fine-grained RFID systems. As used herein, “fine-grained localization systems” refers to RFID systems capable of identifying a location of an RFID target and with an accuracy in the range of about 10 cm to about 20 cm. Conventional fine-grained RFID systems require physically large (e.g., meter scale) antenna arrangements. A second category of RFID systems includes those systems which utilize commercial RFID readers that may be handheld by a user. Existing handheld RFID systems cannot accurately locate the position of a target.

While systems in the first category may accurately locate a target, they require antennas spaced by meter-scale distances, thus making them unsuitable to be held by a user. To avoid bulky infrastructures, some systems mount antennas on mobile robots to emulate large antenna arrays (i.e., synthetic-aperture radar (SAR)). These SAR systems, however, require that the robot and/or target move along well-defined trajectories (e.g., on a track at constant velocity), making them ill-suited for use as a handheld device.

RFID systems in the second category typically employ a single circularly polarized (CP) RF antenna, which may allow them to power up and identify RFID targets irrespective of their orientation. The circular polarization, however, adds an intractable phase to the target's channel when the target orientation changes, even if the target remains in the same location. The change in orientation makes accurate localization difficult. This limits the ability of such systems to perform phase-based localization. Thus, existing handheld systems are typically only capable of detecting the presence of targets and are not capable of accurately localizing (i.e., identifying a location of) RFID targets.

Circularly polarized (CP) RFID targets are also known. However, CP RFID targets are more expensive and larger than linearly polarized (LP) RFID targets. Accordingly, CP RFID targets are infrequently used.

### SUMMARY

Aspects of the present disclosure generally relate to a handheld radio frequency identification (RFID) system capable of performing fine-grained RFID localization independent from the physical orientation of an RFID target. According to one or more aspects, the systems and methods detailed herein enable robust, accurate (i.e., fine-grained), and real-time localization of RFID targets.

One aspect of the concepts, systems and methods described herein provides a mechanism for localizing RFID targets regardless of target orientation through software-controlled polarization of two linearly polarized (LP) antennas.

Another aspect of the concepts, systems and methods described herein include concurrently discovering and localizing targets with zero processing overhead regardless of target orientation.

Still another aspect of the concepts, systems and methods described herein provide for an end-to-end handheld system addressing a number of practical challenges in self-interference, efficient inventorying, and self-localization.

According to one aspect, a method of discovering an RFID target may include generating a first RF signal from a first LP antenna and generating a second RF signal from a second LP antenna. The first and second RF signals may have a relative phase shift therebetween. The first RF signal may be transmitted from the first LP antenna and the second RF signal may be transmitted from the second LP antenna. The transmission of the first RF signal and the second RF signal generates an RF discovery signal.

The method can include one or more of the following features alone or in combination. The first and second LP antennas may be orthogonal. The relative phase shift may be 90°. The RF discovery signal may include a circularly polarized (CP) RF signal. The RF discovery signal may provide a power source to the RFID target. The RF discovery signal may be a vector addition of the first and second RF signals. The phase and amplitude of the first RF signal may be independently controlled from the phase and amplitude of the second RF signal, respectively. The method may further include receiving a first RF response signal and a second RF response signal from the RFID target. The method may also further include generating an RF discovery response signal by combining the first RF response signal and the second RF response signal with a 90-degree phase shift. The method may yet further include decoding the RF discovery response signal into RFID target identification information. The method may further include generating a third RF signal from the first antenna and a fourth RF signal from the second antenna, where the third and fourth RF signals may have the same phase. The method may also include transmitting the third RF signal from the first LP antenna and transmitting the fourth RF signal from the second LP antenna. The concurrent transmission of the third RF signal and the fourth RF signal may generate an RF localization signal. The RF localization signal may be an LP RF signal at an angle, where the angle may be representative of an orientation of the RFID target relative to the first or second LP antenna. The discovery and localization RF signals may be transmitted substantially concurrently. The discovery and localization RF signals may be transmitted at different frequencies.

According to one aspect, a system for localizing a RFID target may include a mobile device including one or more sensors configured to determine a first location of the mobile device in an environment. An RFID system may be coupled to the mobile device and configured to receive an RF signal from the RFID target. A processor may be coupled to the RFID system configured to locate the RFID target based on the RF signal and the first location.

The system may include one or more of the following features alone or in combination. The self-localizing mobile device may include a camera. The one or more sensors may include one or more of an inertial measurement unit, an accelerometer, or a gyroscope. The mobile device may be further configured to determine a second location of the mobile device and processor may be further configured to locate the RFID target based on the first location, the second location, and the RF signal. The processor may be configured to locate the RFID target based on a plurality of RF signals from a plurality of RFID targets. The plurality of RF signals may be combined in a voting mechanism to locate the RFID target. The mobile device may be further configured to determine the first location based on the RF signal.

According to another aspect, a system may include a first LP antenna and a second LP antenna orthogonal to the first LP antenna. A processor may be coupled to the first and second LP antennas and configured to generate a first RF signal and a second RF signal having a phase shift from the first RF signal. A transmitter may be adapted to transmit the first RF signal from the first LP antenna and transmit the second RF signal from the second LP antenna. The concurrent transmission of the first RF signal and the second RF signal may generate a CP RF signal.

The system can include one or more of the following features alone or in combination. The first LP antenna may be adapted to receive a first RF response signal from the RFID target and the second LP antenna may be adapted to receive a second RF response signal from the RFID target. The processor may be adapted to generate a CP RF response signal from the first RF response signal and the second RF response signal.

According to another aspect, a method of localizing a RFID target may include generating a CP RF discovery signal and a first power level. A linearly polarized (LP) RF localization signal may be generated. the CP RF discovery signal may be transmitted from one or more orthogonal antennas to an RFID target at a first frequency. The LP RF localization signal may be transmitted from the one or more antennas to the RFID target at a second frequency.

The method can include one or more of the following features alone or in combination. Generating the first CP RF signal may further include generating a first LP RF signal and generating a second LP RF signal, with the first and second LP RF signals having a relative phase shift therebetween. The first LP RF signal may be transmitted from a first LP antenna and the second LP RF signal may be transmitted from a second LP antenna. The second LP antenna may be orthogonal to the first LP antenna. Generating the LP RF localization signal may further include generating a first LP RF signal and generating a second LP RF signal. The amplitudes of the first LP RF signal and the second LP RF signal may be independently controlled. The first LP RF signal may be transmitted from a first LP antenna and the second LP RF signal may be transmitted from a second LP antenna substantially concurrently. The second LP antenna may be orthogonal to the first LP antenna.

### BRIEF DESCRIPTION OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, aspects of the present disclosure are illustrated by way of example and not limitation in the figures, in which.

FIG. 1A depicts a radio frequency (RF) signal having a circular polarization incident on a radio frequency identification (RFID) target oriented at a first angle.

FIG. 1B depicts an RF signal having circular polarization incident on an RFID target at an angle perpendicular to the RFID target in FIG. 1A.

FIG. 2 depicts axes of rotation of an RFID target with respect to an antenna.

FIG. 3A is a plot of change in phase versus RFID target pitch angle for RF signals having vertical linear, horizontal linear, and circular polarizations.

FIG. 3B is a plot of change in phase versus RFID target yaw angle for RF signals having vertical linear, horizontal linear, and circular polarizations.

FIG. 3C is a plot of change in phase versus RFID target roll angle for RF signals having vertical linear, horizontal linear, and circular polarizations.

FIG. 4 is a block diagram of an RFID system, according to one aspect of the present disclosure.

FIG. 5 depicts a circularly polarized (CP) RF signal formed by two linearly polarized (LP) RF signals, according to one aspect of the present disclosure.

FIG. 6 is a plot of signal-to-noise ratio versus roll angle for RF signals having vertical linear, horizontal linear, and circular polarizations, according to one aspect of the present disclosure.

FIG. 7A depicts the construction of a linearly polarized (LP) RF signal at an angle from two orthogonal signals, according to one aspect of the present disclosure.

FIG. 7B depicts an LP RF signal combined from two orthogonal RF signals with different amplitudes, according to one aspect of the present disclosure.

FIG. 8 is a plot of phase change versus angle as an RFID target rotates in roll, yaw, and pitch, according to one aspect of the present disclosure.

FIG. 9 is a plot of relative signal strength versus roll angle of an RFID target for RF signals having vertical linear, horizontal linear, and circular polarizations, according to one aspect of the present disclosure.

FIG. 10 is a timing diagram of an illustrative schedule, according to one aspect of the present disclosure.

FIG. 11 is a plot of leakage versus frequency for a CP RF signal with and without cross-polarization, according to one aspect of the present disclosure.

FIG. 12 is a block diagram illustrating an architecture of an RFID system, according to one aspect of the present disclosure.

FIG. 13 is a flow diagram of an illustrative method for discovering an RFID target, according to one aspect of the present disclosure.

FIG. 14 is a flow diagram of an illustrative method for localizing an RFID target, according to one aspect of the present disclosure.

FIG. 15 is a flow diagram of an illustrative method of jointly discovering and localizing an RFID target, according to one aspect of the present disclosure.

### DETAILED DESCRIPTION

Aspects of the present disclosure generally provide for a handheld radio frequency identification (RFID) system capable of performing RFID target discovery and fine-grained localization of an RF target. The concepts, systems and techniques described herein apply to any type of RF target. As used herein, the term “RFID target” may include, but is not limited to, an RFID tag, sticker or any other devices (passive or active) responsive to radio frequency (RF) signals, including but not limited to, mmWave backscatter tags, UWB tags, WiFi backscatter tags, sewn-in textile tags, anti-theft security tags, and asset-tracking tags. RFID targets may transfer or otherwise provide information in response to an incident RF signal.

As used herein, the term “localization,” (or “localizing”) refers to processes and/or techniques to determine a location, position, and/or orientation of a discovered RFID target. The term “fine-grained localization” (or “fine-grained localizing”) refers to processes and/or techniques to determine a location, position, and/or orientation of a discovered RFID target to an accuracy in the range of about 10 cm to about 20 cm. A “fine-grained RFID system” (or more simply an “RFID system”) refers to an RFID system capable of identifying a location of an RFID target to an accuracy in the range of about 10 cm to about 20 cm.

As used herein, “discovery” may include the process and/or techniques of detecting, and/or powering, and/or identifying an RFID target within an environment. The term “environment” includes both indoor and/or outdoor environments.

In embodiments, an RFID system may comprise two or more orthogonally disposed, linearly polarized (LP) antennas with at least two of the two or more LP antennas having independent phase and amplitude control. According to one or more aspects of the present disclosure, the RFID system may use the two orthogonal LP antennas to generate a circularly polarized (CP) RF signal to discover (i.e., detect, power, and identify) a target. The RFID system utilizes linearly polarized (LP) RF signals from the two orthogonal antennas to accurately locate a position of the RFID target (i.e., to accomplish “fine-grained localization” of the target. RFID systems provided in accordance with the concepts described herein are capable of performing discovery and localization of an RFID target independent of the target's orientation. In embodiments, RFID systems provided in accordance with the concepts described herein may concurrently discover and localize an RFID target at any orientation.

In operation, a user may carry or otherwise move an RFID system around an environment. In embodiments an RFID system provided in accordance with concepts described herein may be provided as a hand-held system (e.g., a handset, reader or scanner) or as any type of mobile system. The RFID system emits RF signals and may self-localize as it discovers (i.e., detects the existence of) and localizes RFID targets within its radio range.

Information received by an RFID system may allow the system to create a digital map of environments (e.g., indoor environments) populated with targeted (or tagged) items (objects) in three-dimensional space.

In contrast to prior approaches for fine-grained RFID localization that are constrained by the radio range of a deployed relatively large infrastructure, aspects of the disclosed system may cover any area in which a user moves, making aspects of the disclosed system significantly more cost-effective and scalable than large-scale antenna deployments.

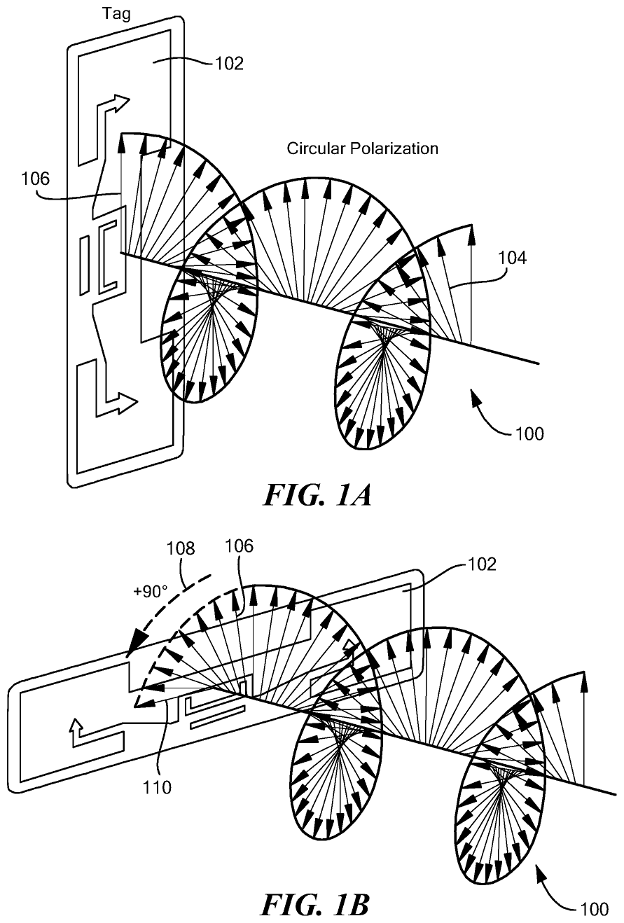

Turning now to FIGS. 1A and 1B, shown is an RF localization signal 100 (i.e., a signal emitted from an RFID system to discover and power a tag). RF localization signal 100 is circularly polarized. RF localization signal 100 is incident on an RFID target 102. The RFID target 102 includes an LP antenna responsive to RF localization signals such as RF localization signal 100. Thus, RFID target 102 may be said to be LP.

The RFID target 102 is shown in a vertical orientation in FIGS. 1A and 1n a horizontal orientation in FIG. 1B. A comparison of the incident RF signal 100 on the RFID target 102 at different orientations illustrates why localizing RFID target 102 with an RFID system which uses circularly polarized (CP) antennas suffers from an unknown phase offset. As depicted in FIG. 1A, the electric field 104 (shown in arrows) in CP RF transmissions rotates as the RF localization signal 100 travels (propagates) in space toward the RFID target. Since the RFID target 102 is LP, it powers-up (and responds) when an electric field of RF signal 100 is aligned with the orientation of the antenna of RFID target 102. Thus, as shown in FIG. 1A, the vertically oriented RFID target 102 (or more particularly the vertically oriented antenna of RFID target 102) would reflect the incident RF localization signal 100 when the electric field 104 is vertical. The amplitude of an RF signal reflected from the LP RF antenna of RFID target 102 is strongest (i.e., the reflected signal has the highest amplitude) when the orientation of the LP RF antenna of RFID target 102 is aligned with (i.e., is oriented in the same direction as) the electric field of the RF signal incident on the antenna of RFID target 102.

On the other hand, if the RFID target 102 (or RFID antenna) is rotated, for example 90° as shown in FIG. 1B, then a vertically received electric field vector 106 is not aligned with the linear antenna of RFID target 102. Rather, as indicated by arc 108 in FIG. 1B, the RF localization signal 100 must propagate an additional distance for the electric field to be aligned with the RFID target 102. This adds a fictitious distance and creates a phase offset, here 90°, that is dependent on the RFID's orientation (i.e., the angle of the target's orientation when an incident electric field vector 110 is received at the RFID target 102). As detailed below, only rotation in the circular polarization plane impacts phase. In practical systems, the orientation of an RFID target is often unknown, and the electric field of a CP RF signal emitted by an RFID system (e.g., an RFID scanner or reader) may not be aligned with the linear antenna of the RFID target. Thus, in this case an RFID system may be unable to accurately localize the RFID target 102 (e.g., receive localization information which allows accurate determination of a location of the RFID target 102).

For these reasons, known RFID systems (e.g., handheld target readers or scanners) which include circularly polarized (CP) antennas are incapable of performing accurate phase-based localization. RFID systems rely on accurate phase measurements, so any distortions to phase may make accurate localization of an RFID target very challenging. In principle, one could modify an RFID system by replacing a CP antenna with an LP antenna. An RFID system which includes a single LP antenna, however, cannot discover (i.e., detect, power, and identify) RFID targets comprising a single LP antenna when the linear antenna of the RFID target is positioned (or oriented) such that it is orthogonal (or near orthogonal) to the orientation of a linear antenna in the RFID system. This may result in the RFID system missing targets in an environment and is a reason why portable readers rely on CP antennas.

As detailed above, a number of known (i.e., conventional) RFID systems include CP (CP) RF antennas because the use of a CP RF antenna allows the RFID reader to detect, power, and identify targets regardless of the orientation of the target with respect to the reader. However, CP RF antennas fail to enable an RFID system to achieve fine-grained localization of RFID targets when the RFID targets have arbitrary orientations (e.g., arbitrary positions or rotations).

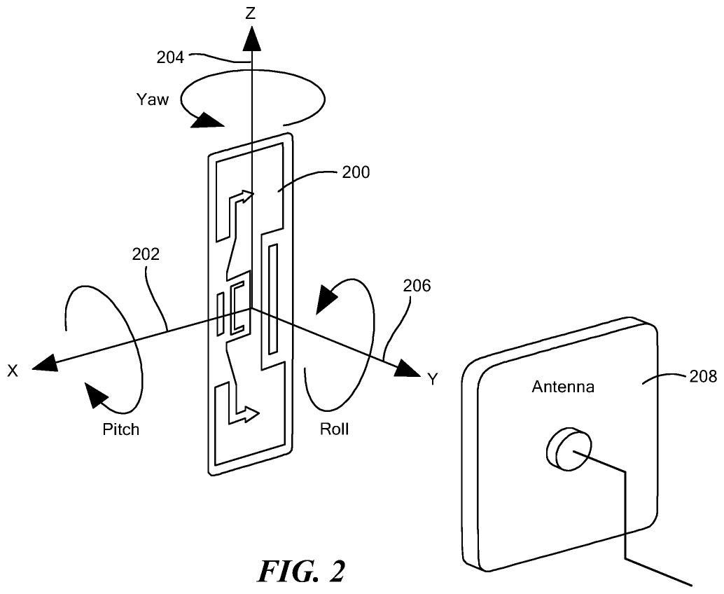

FIG. 2 depicts an exemplary RFID target 200 (or more simply “target” 200) comprising an LP antenna. As illustrated in FIG. 2, target 200 may move with six degrees of freedom including rotation around all axes in a Cartesian coordinate system. Each movement of RFID target 200 with respect to an antenna 208 changes the orientation of the RFID target with respect to antenna 208. Antenna 208 may be part of an RFID system.

The target 200 may rotate about a three-dimensional space according to the pitch (x-axis) 202, yaw (z-axis) 204 and roll (y-axis) 206. As detailed above in connection with FIGS. 1A and 1B, changing the target's roll (i.e., rotation of the target about the y-axis illustrated in FIG. 2) adds a phase offset if antenna 208 is a CP antenna. This is because the target 200 has the strongest reflection when aligned with the electric field of an RF signal incident on the target (e.g., as shown in FIG. 1A). When the RFID target is rotated to a different angle, (e.g., as shown in FIG. 1B), the RF signal travels a different distance for the electrical field of the RF signal to be aligned with the LP antenna of the RFID target. This introduces a phase offset that is dependent on the rotation of the target. Thus, when the rotation of the target is unknown, the associated phase offset is also unknown.

In contrast to changing a roll angle of a target relative an antenna of an RFID system, changing the target's pitch (x-axis) or yaw (z-axis) does not induce a phase offset, since rotations about the x and z axis do not change the direction of the target's polarization relative to the CP RF signal.

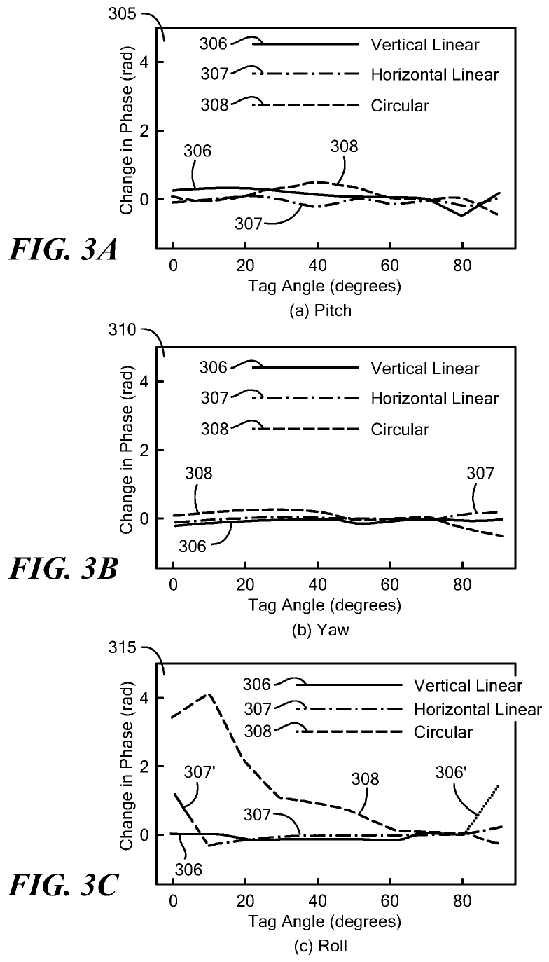

FIGS. 3A-C are plots of the change in phase of a target's response (relative to the target's response at an initial orientation) as a function of the target's angle for each of the three rotation directions shown in FIG. 2. According to aspects of the disclosure, in a scenario in which a target and an RFID tracking system are placed at a fixed distance and the target is rotated in intervals of 10° in the three directions (roll, pitch, yaw) the average phase and SNR may be measured. According to one aspect, measurements may be made for each of a vertically polarized RF signal 306, a horizontally polarized RF signal 307, and a CP (Circular) RF signal 308. The measurements may range from 0° to 90°, since the remaining angles follow the same pattern. In the plots of FIGS. 3A-C, according to one aspect, solid lines indicate the SNR at that angle is above a threshold (e.g., −0.25 dB), and dotted lines 306′, 307′, indicate that the SNR is below that threshold. FIG. 3A is a plot 305 of the change in phase response for pitch (rotation about the x-axis). The plot 310 of FIG. 3B shows the change in phase response for yaw (rotation about the y-axis). FIG. 3C is a plot 315 of the change in phase response for roll (rotation about the y-axis).

The plots 305, 310 of FIGS. 3A and 3B indicate that for pitch and yaw, respectively, the phase may remain substantially consistent (i.e., the change in phase remains near zero) for the CP RF signal (as well as for the vertical and horizontal linear RF signals). The plot 315 of FIG. 3C demonstrates the problem arising from changes in the target's roll. The phase of the CP RF signal 308 changes drastically, from about 3.2 radians to −0.4 radians across the 90° span, despite the distance to the target remaining fixed. This may indicate that the total change in phase is about 3.6 radians (more than π radians). This large change may result in meters of error in phase-based localization. In contrast, for LP RF signals 306, 307, the phase remains the same across all three rotations (if the target is powered up). This is expected since the relative rotation between the RF signal's electric field and the RFID target remains fixed over time. Therefore, the RFID target's phase does not change with rotation about those axes.

To address the challenges of discovering and localizing RFID targets at different orientations detailed above, an RFID system according to one or more aspects of the disclosure comprises orthogonally disposed, LP antennas with independent phase and amplitude control, referred to herein as complex-controlled polarization (CCP). According to one or more aspects of the present disclosure, the RFID systems described herein may use the two orthogonal LP antennas to generate a CP RF signal to discover (i.e., detect, power, and/or identify) a target. The RFID system may further generate an LP RF signal from the two orthogonally disposed LP antennas to accurately localize the target. The discovery and localization of an RFID target may be achieved independent of the target's orientation.

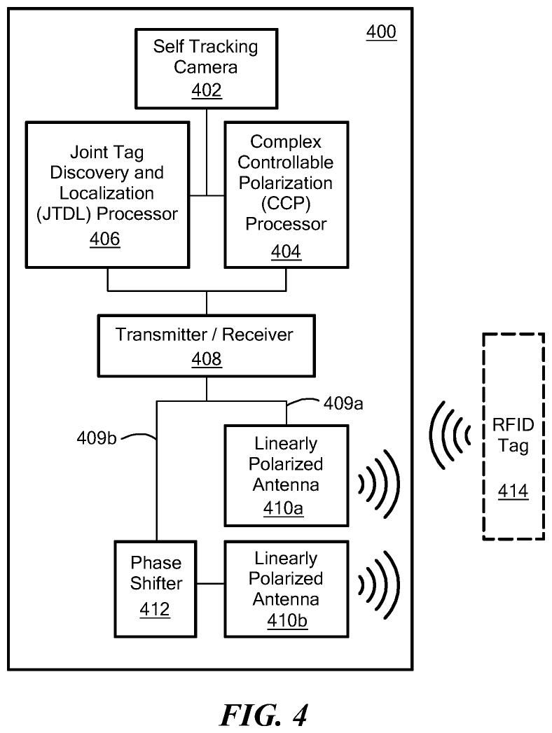

Turning now to FIG. 4, shown is a system diagram of an RFID system capable of performing “fine-grained” localization (i.e., localization of an RFID target to a distance in the range of about 10 cm to about 20 cm). The RFID system 400 includes a self-tracking camera 402, such as an Intel Realsense T265, having a built-in visual-inertial odometry (VIO), a CCP processor 404 and a joint target discovery and localization (JTDL) processor 406. The configurations and operations of CCP processor 404 and JDTL processor 406 are further detailed below. The CCP processor 404 and JDTL processor 406 may provide respective information and/or instructions to a transmitter/receiver 408 coupled to one or more LP antennas, with two LP antennas 410a, 410b being shown in the example system of FIG. 4. In embodiments, transmitter/receiver 408 may be provided as separate transmit and receive circuits. In embodiments transmitter/receiver 408 may be provided as a transmit-receive module (T/R module).

According to one aspect, the LP antennas 410a, 410b may be disposed orthogonal to each other. After reading the disclosure provided herein, those of ordinary skill in the art will appreciate that any type of LP antenna may be used. This includes but is not limited to a bowtie antenna, a dipole antenna and LPDA antenna. Antenna 410a, 410b may be provided as any type of patch antenna, or more generally, as any type of printed circuit antenna. In embodiments, either, or both of, antenna 410a, 410 may comprise a single antenna element or an array of antenna elements. In embodiments, antenna 410a, 410b may be provided from a single antenna element capable of emitting or receiving orthogonally polarized RF signals (e.g., a single antenna element capable of emitting or receiving dual polarizations such as vertically and horizontally polarized RF signals). For example, in embodiments, antenna 410a, 410b may be provided as a single, dual linear polarization microstrip patch antenna. As another example, antennas 410a, 410b may be provided as an LP crossed dipole antenna. One skilled in the art will recognize that the antennas 410a, 410b need not be the same antenna element so long as the differences in antenna characteristics are properly accounted for and the two antennas 410a, 410b are linearly polarized.

Although in the example embodiment of FIG. 4, the transmitter/receiver 408 is shown coupled to a pair of antennas, in embodiments any number of antenna elements (i.e., one or more antenna elements) may be used as long as the system is able to provide orthogonally polarized RF signals (e.g. a vertically polarized RF signal and a horizontally polarized RF signal) After reading the disclosure provided herein, one skilled in the art will appreciate how to select the number and type of antenna elements to suit the needs of a particular application.

According to one aspect, the RFID system 400 may include one or more phase shifters 412 coupled between the transmitter/receiver 408 and respective ones of the LP antennas 410a, 410b. In the example embodiment of FIG. 4, a single-phase shifter is coupled between transmitter/receiver 408 and LP antenna 410b. Phase shifter 412 may be controlled to provide a phase shift in the transmit/receive signal paths (here shown as a single signal path 409b) between transmitter/receiver 408 and LP antenna 410b. In this way, a desired phase shift (or relative phase offset) may be introduced between the signal path 409a between transmitter/receiver 408 and LP antenna 410a and the signal path 409b between transmitter/receiver 408 and LP antenna 410b. In embodiments, one or more phase shifters may be provided in each signal path 409a, 409b. In embodiments which comprise more than two antennas, one or more phase shifters may be provided in some or all of the signal paths which exist between transmitter and receiver circuitry and the antennas. In general, the system should preferably include components (e.g., one or more phase shifters or any phase shifting component(s) or technique(s) which can provide a phase shift between RF signals having orthogonal polarizations generated by the system 400.

As described herein the RFID system 400 may transmit and receive RF signals to discover and/or localize an RFID target 414. To discover an RFID target 414 across orientations, the CCP processor 404 of the RFID system 400 may generate a CP RF signal by feeding the same RF signal from the transmitter/receiver 408 to both LP antennas 410a, 410b. However, once RF signal is passed through the phase shifter 412 to introduce a 90° phase shift between the two signals. As detailed below, generating two RF signals from the orthogonal, LP antennas 410a, 410b, one having a 90° phase shift from the other, generates a CP RF signal able to discover an RFID target at any orientation.

This approach is in contrast to known systems which utilize a single CP antenna.

According to one aspect, and as further detailed below, the RFID system may determine the orientation of the RFID target by decoding the RF signals reflected by the RFID target. The LP antennas 410a, 410b system may receive LP RF response signals from the RFID target. A 90° phase shift may be introduced to one of the LP RF signals and combined with the other LP RF signal to generate a CP RF signal. RFID target orientation information may then be extracted from the generated CP RF signal.

Techniques to discover an RFID target (such as RFID target 414) and determine an orientation of the discovered RFID target with an RFID system (such as RFID system 400) will be described in detail below. Suffice it here to say that with the RFID target 414 properly discovered, including knowing the RFID target's orientation, the RFID system 400 may localize the RFID target 414 by generating an LP RF signal at an angle matching the orientation of the RFID target 414.

As detailed below, the CCP processor 404 may generate two LP RF signals having independently controlled amplitudes. The LP RF signals may be transmitted respectively from each of the LP antennas. According to one aspect, because the orientation of the RFID target 414 is known, the CCP processor 404 may vary the amplitudes of each LP RF signal to form an LP localization RF signal at an angle matching the orientation of the RFID target 414. As described below, the operations of discovering and locating an RFID target 414 may be independent, or preferably the JTDL processor may work in conjunction with the CCP processor to combine into a joint target discovery and localization operation.

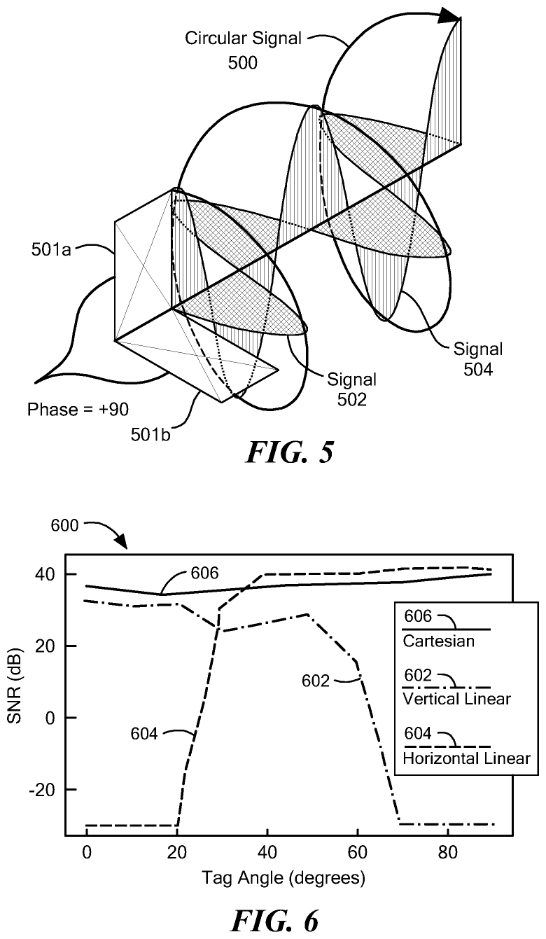

FIG. 5 depicts the generation of CP RF signal 500 for discovering an RFID target. The use of two orthogonal LP antennas 501a, 501b may form a CP RF signal 500 for detecting, powering and identifying the RFID target at any angle. Antenna 501a, 501b may be provided as bowtie antennas or as any of the antenna types described above in conjunction with FIG. 4. The first LP antenna 510aa may transmit a first RF signal 502 having a first polarization, here illustrated as a substantially vertical polarization. The second LP antenna 501b may substantially simultaneously or concurrently transmit a second RF signal 504, substantially identical to the first RF signal 502, but, but having a second linear polarization, here a substantially horizontal polarization. Thus, RF signals 502, 504 are provided having substantially orthogonal polarizations (and ideally precisely orthogonal polarizations). The second LP RF signal 504 may be further phase-shifted by 90°. At each point in time, the resulting CP RF signal 500 may be the vector addition of the two RF signals 502, 504. As the RF signals propagate toward an RFID target, the phase offset between the two causes the electronic field vector to rotate, creating the CP RF signal 500. This CP RF signal 500 can discover RFID targets comprising any type of antenna and any physical orientations relative to RFID system 400 (FIG. 4) in the same way as an RFID system comprising a CP antenna.

While the LP antennas 501a, 501b may be shown and described herein as having vertical or horizontal orientations or polarizations, one skilled in the art will recognize that the scope of the present disclosure is not limited only to those orientations in space. Indeed, antennas oriented at any angle, so long as they are oriented relative to each other as described herein, are within the scope of the disclosure.

According to one aspect, the following RF signals may be transmitted:

$${TX}_{horiz , 1} = x \& {TX}_{vert , 1} = {xe}^{j π / 2} \qquad ( 1 )$$

where TX_{horiz,1} and TX_{vert,1} are the transmitted RF signals on the two orthogonal antennas (horizontal 501b and vertical 501a), and x is the time-domain (modulated) RF signal.

Such an approach is inherently different from typical MIMO (multi-input multi-output) systems in both theory and design. This is because, in MIMO systems, antennas may have the same polarization, and adding a phase offset does not induce a time-varying polarization change of the transmitted RF signals.

In addition to powering the target, the RFID system may be further configured to decode the target's response to the RFID system's CP RF discovery signal. As the RFID target may only include an LP antenna, any RF signal returned will be LP. Similarly, because the RFID system uses LP antennas, it may only receive LP RF signals. In order to properly decode an RF discovery response signal from the RFID target, the RFID localization may generate a CP RF response signal. Like during transmission, the RFID system 400 may generate the CP RF response signal by combining the reflected RF signals incident on the two LP antennas and adding a 90° phase shift to one RF signal. According to one aspect, this ensures the system's ability to discover the RFID target at all orientations.

According to one aspect of the disclosure, the self-localizing features of the RFID system may be leveraged to assist in locating RFID targets. In such a system, a mobile (i.e., handheld) device, such as a camera, having one or more sensors may be configured to determine a location of the mobile device in an environment (i.e., self-localize). The RFID system may communicate with the mobile device and be configured to receive an RF signal from the RFID target. A processor, such as the CCP processor 404 and/or JTDL processor 406, may be configured to locate the RFID target based on the RF signal and the location of the mobile device obtained through self-localization.

According to one aspect, the sensors of the mobile device may include one or more of an inertial measurement unit, an accelerometer, a gyroscope. As the mobile device moves through the environment, the mobile device may be further configured to determine additional locations of the mobile device. The processor may be further configured to locate the RFID target based on the initial location, the additional locations, and the RF signal, as described herein. The processor may be further configured to locate the RFID target based on a plurality of RF signals from a plurality of RFID targets. According to one aspect, further comprising a voting mechanism configured to receive and combine a plurality of RF signals to locate the RFID target. The use of a voting mechanism may improve the location accuracy of the RFID target. The mobile device may also be configured to use the RF signal from the RFID target to self-localize.

To demonstrate the RFID system's ability to discover an RFID target at all angles, FIG. 6 shows a plot 600 of the maximum target SNR versus roll angle for the RFID system 606. For comparison, the plot 600 further shows the SNR as a function of roll angle for RF discovery signals from a vertical LP antenna 602 and a horizontally LP antenna 604. As shown in the plot 600, when an RFID target is orthogonal to the polarization of an RF signal incident on the target, the antenna cannot read the target (the SNR is −30 dB). Specifically, the horizontal (90°) antenna 604 cannot read targets from 0° to 20°. Similarly, the vertical (0°) antenna 602 cannot read from 70° to 90°. When the target angle is not orthogonal to the polarization, the antennas can read the target. For example, the vertical antenna 602 (0°) can read targets with high SNR between 0° and 70°. This shows that polarization mismatch prevents an LP antenna from reading a target when within 20° of orthogonality. As explained below, unlike either of the LP antennas, the RFID system is able to achieve a high SNR (over 34 dB) across all angles, which further shows the system successfully creates CP RF signals that can power and read targets at all angles.

As explained above, prior art RFID systems typically comprise CP antennas. However, as also explained, using CP antennas for localization may introduce an unknown phase offset that will limit the localization accuracy.

However, with an RFID system provided in accordance with the concepts described herein, if a target is vertical or horizontal, then the transmitter can simply transmit along the vertically polarized or horizontally polarized antenna, respectively. If a target is not horizontally or vertically oriented, however, an RFID system provided in accordance with the concepts described herein (e.g., RFID system 400) is capable of transmitting an LP signal having an orientation which is substantially aligned with orientation of the target.

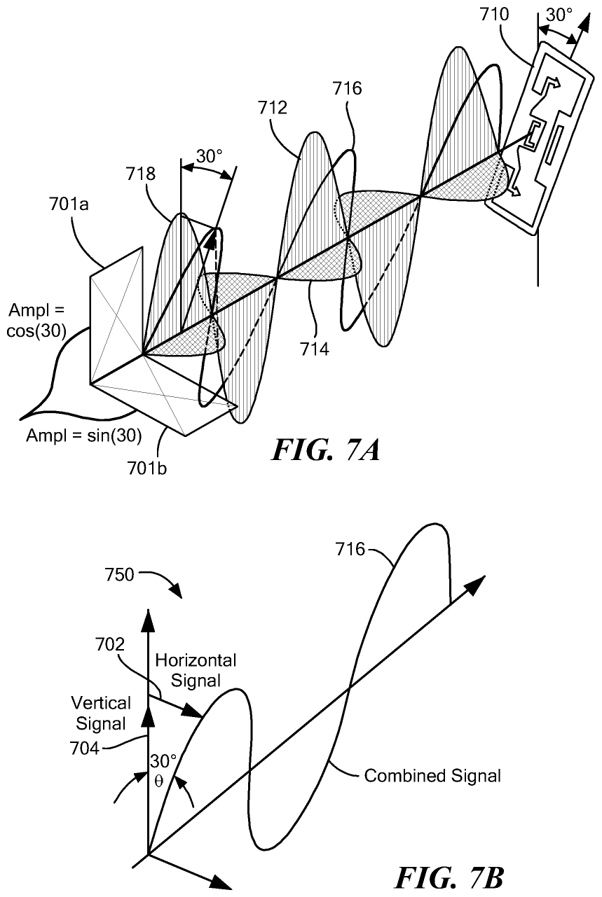

RFID systems without this capability have limitations. For example, as shown in FIG. 7A, a target 710 is at an angle θ=30° from vertical. If an RFID system uses only a vertical antenna (e.g., antenna 410a in FIG. 4), the target may receive only a fraction of the power.

Furthermore, RFID systems comprising only a single LP antenna for localization may also give inaccurate readings. As shown in FIG. 3C, and discussed above, using an LP RF signal when localizing a target may result in polarization mismatch, causing a large drop in the SNR when the orientation of the target is substantially or near perpendicular to the RF signal. (The dotted lines 306′, 307′ denote a very low SNR, when each of the horizontally and vertically polarized antennas are near orthogonal to the target). Such SNR drop would impact channel estimates and lead to an inaccurate location estimate. To overcome this, according to one aspect, the RFID system can construct an LP RF signal that aligns with the target's orientation, minimizing losses from polarization mismatch.

According to one aspect of the disclosure, RFID systems provided in accordance with the concepts described herein may localize targets across varying orientations. FIG. 7A depicts the construction of an RF localization signal 716, according to one aspect of the disclosure. The system may substantially simultaneously (and ideally simultaneously) transmit (emit or send) vertical 712 and horizontal 714 LP RF signals. Unlike the CP signal generated to power the RFID target, described above, the two RF signals 712, 714 are sent with no phase shift (e.g., phase shifter 413 is set so as to provide zero phase shift between the two RF signals). The resulting RF signal 716 may be the vector addition of the vertical RF signal 712 and the horizontal RF signal 714, creating an LP RF signal 716 at an angle 718, for example 30°.

According to one aspect, to localize a powered target, the system will preferably generate the LP RF signal 716 whose orientation is aligned with the RFID target. To do so, the RFID system may perform independent amplitude control across two LP orthogonally disposed antennas (such as antenna 410a, 410b, in FIG. 4). Specifically, for example in generating a 30° LP RF signal, rather than transmitting from only one of the antennas, the system may transmit the same RF signal but with

$$cos ( π \frac{30}{180} ) *$$

amplitude (vertical RF signal 712) along vertical antenna 701a (which may be the same as antenna 410a in FIG. 4) and

$$sin ( π \frac{30}{180} )$$

amplitude (horizontal RF signal 714) along the horizontal antenna 701b (which may be the same as antenna 410b in FIG. 4) (with no phase offset). Accordingly, an LP RF signal 716 at the corresponding angle (30°) may be generated, matching the orientation of the RFID target 710. Such an approach may be applied at any angle, allowing the system to achieve the highest SNR across orientations, and receive a response without a phase offset, enabling accurate localization.

According to one aspect, to change the orientation of an RF localization signal, an RFID system (e.g., RFID system 400 in FIG. 4), via a CCP processor (e.g., CCP processor 404 in FIG. 4), for example, may change the relative amplitudes of the RF signals.

FIG. 7B is a simplified plot 750 depicting an exemplary RF localization signal 716 of FIG. 7A where the horizontal and vertical RF signals are transmitted with different amplitudes. As a result of the difference in relative amplitudes, the combined RF signal 716 may be formed at an angle θ, for example at 30°. That is, signal 716 comprises a horizontal signal component 702 (which may be provided by a horizontally disposed (or oriented) antenna element such as antenna element 701b in FIG. 7A) and a vertical signal component 704 (which may be provided by a vertically disposed (or oriented) antenna element such as antenna element 701a in FIG. 7A). When the horizontal and vertical signal components 702, 704 are added to together they result in signal 716 having an orientation of 30°. Thus, by controlling amplitudes of RF signals generated horizontally and vertically disposed antenna elements the orientation of an RF localization signal (e.g., RF localization signal 716) may be controlled. Accordingly, through independent amplitude control, the system can construct an LP RF localization signal such as RF localization signal 716 at any angle.

Generally, to generate an RF localization signal at a given angle θ, the RFID system may need to compute the necessary amplitudes. According to one aspect, the localization RF signal may be considered the hypotenuse of a right triangle formed by two orthogonal RF signals. Therefore, to construct an RF signal at angle θ, the system may transmit:

$${TX}_{horiz , 2} = cos ( θ ) x \& {TX}_{vert , 2} = sin ( θ ) x \qquad ( 2 )$$

where TX_{horiz,2} and TX_{vert,2} are the RF signals sent on the horizontal and vertical antennas respectively, and x is the modulated RF signal.

According to one aspect, when the target reflects (backscatters) an RF signal incident thereon from an RFID system (RF localization signal), the RFID system may receive the response on two orthogonal receive antennas. Each antenna will receive only the component of the target's response that is parallel to its polarization, again resulting in polarization mismatch. While known systems may simply use the RF signal with the strongest response for localization, doing so may lead to the loss of information from the other antenna, limiting the SNR. For example, when an RFID target is oriented at 45°, each receive antenna may receive the same amount of power from the target, so dropping the received RF signal from one antenna would result in losing half of the received power.

Instead, according to one aspect, the RFID system may combine the two RF responses to construct an LP RF receive signal that substantially matches the target's orientation. This combination may optimize the power of the received RF signal, maximizing the SNR and therefore allowing accurate localization at further ranges. To combine the two RF receive signals into a single LP RF signal, the system, including for example the CCP processor, may project the two received RF signals onto an angle θ in a similar manner to the transmitted RF signal. That is:

$${RX}_{comb} = cos ( θ ) {RX}_{horiz} + sin ( θ ) {RX}_{vert} \qquad ( 3 )$$

where RX_{comb} is the combined RF signal, RX_{horiz} and RXᵥₑᵣₜ are the received RF signals on the horizontal and vertical antennas.

While the addition of a phase offset, rather than an amplitude offset, between the transmitted RF signals on the vertical and horizontal antennas may be considered, adding a phase offset would not lead to LP RF signals but rather CP ones. This is because a phase offset is equivalent to adding a delay between the transmitted RF signals, causing them to rotate with respect to each other over time, like the CP RF discovery signal using on a 90° phase offset described above. Similarly, other phase offsets may result in elliptical polarizations with different major and minor axes (rather than linear polarizations).

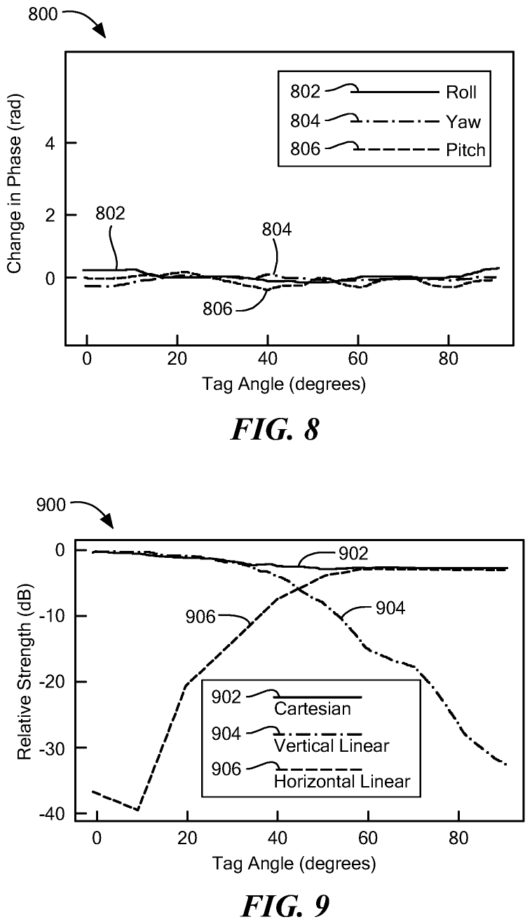

According to one aspect of the disclosure, the RFID system may be implemented in an environment where the RFID system and a target are placed at a fixed distance and the target is rotated in all three directions (e.g., pitch, yaw, and roll). The change in phase (relative to the response at an initial orientation) for each rotation may be measured. FIG. 8 is a plot 800 showing the change in phase as a function of the target's roll 802, yaw 804, and pitch 806. The range of the phase across all target angles is, according to one aspect, below 0.2, 0.3, and 0.2 radians for roll, pitch, and yaw, respectively. Such variations are minimal and are significantly smaller than those observed with the CP antenna (FIG. 3C). The consistency of the phase across target rotations demonstrates that the RFID system may read orientation-independent target phases, which is critical for accurate localization.

According to one aspect, the RFID system's ability to receive equivalent power across all target rotations may be demonstrated. To do so, the RFID system and the RFID target may be placed at a fixed distance and the RFID target may be rotated about the y-axis (i.e., roll) in intervals of about 10°. To ensure the target is powered for every trial, separate antennas for powering and reading the target may be placed. Accordingly, the channel strength at each angle may be measured and compared to the RF signal strength when using a single LP antenna, both horizontal and vertical.

FIG. 9 is a plot 900, according to one aspect, showing the normalized RF signal strength as received by the RFID system (relative to the max) versus target roll for an RFID system 902, a vertical antenna 904, and a horizontal antenna 906. For both horizontal)(90° 906 and vertical)(0° 904 antennas, the impact of polarization mismatch can be seen by a significant decline of over 25 dB in signal strength as the target moves closer to perpendicular. For the RFID system, however, the signal strength remains consistent across all target angles, varying by less than 3 dB. Accordingly, the RFID system may effectively overcome polarization mismatch.

According to one aspect of the disclosure, the CCP protocol of generating different polarizations for discovery and localization may be leveraged to perform both processes simultaneously, rather than serially, to make the system efficient. Further, relying on the same antennas for discovery and localization allows the device to be compact. Doing so, however, may be complicated by the need to realize simultaneously different polarizations and address self-interference across all simultaneous transmissions and polarizations.

According to aspects of the present disclosure, the RFID systems described herein may include joint target discovery and localization (JTDL). According to one aspect, the system may decouple discovering the RFID targets from localizing them. Specifically, as detailed herein, the JTDL processor may work in conjunction with the CCP processor to generate RF signals to discover the targets (e.g., in the UHF ISM band) in a CP fashion while transmitting localization frequencies outside the ISM band in an LP manner. Aspects of the systems described herein expand on such methodology by transmitting different frequencies at different times from the horizontal and vertical antennas and combining them in post-processing to emulate different polarizations and synthesize any RF signal orientation.

According to one aspect, the RFID system may localize targets during a standard RFID inventorying process without additional overhead for localization procedures. To accomplish this, the RFID system may rely on dual-frequency excitation, according to aspects of the present disclosure. Accordingly, two RF signals of different frequencies may be sent to the RFID target: one high-power RF signal in the UHF ISM band to discover the target and one low-power RF signal for sensing. While the high-power RF signal should preferably remain within the target's narrow bandwidth to successfully discover the target, the RF localization signal may be sent at any frequency. Since the RFID target may be frequency agnostic, the target will reflect both RF signals. Thus, by varying the RF localization signal frequency across a wide bandwidth, this technique can be used to measure ultra-wideband (UWB) channel estimates for accurate localization.

According to aspects of the disclosure, the CCP localization system may simultaneously send a CP RF signal to power the target and an LP RF signal to localize it. Since the RF signals may be at different frequencies, the system can send both from the same LP antennas without impacting either RF signals' polarizations.

One challenge with performing joint discovery and localization may be that the angle of each target is unknown a priori, making it difficult to construct an LP RF transmit signal to match the target's angle. To overcome this hurdle, the RFID system may send RF signals at any given frequency on both antennas but at different times. This allows measuring the horizontal and vertical components of the target response and combining them in post-processing to achieve optimal SNR. The technique follows a three-step process including transmission, angle detection, and distance estimation.

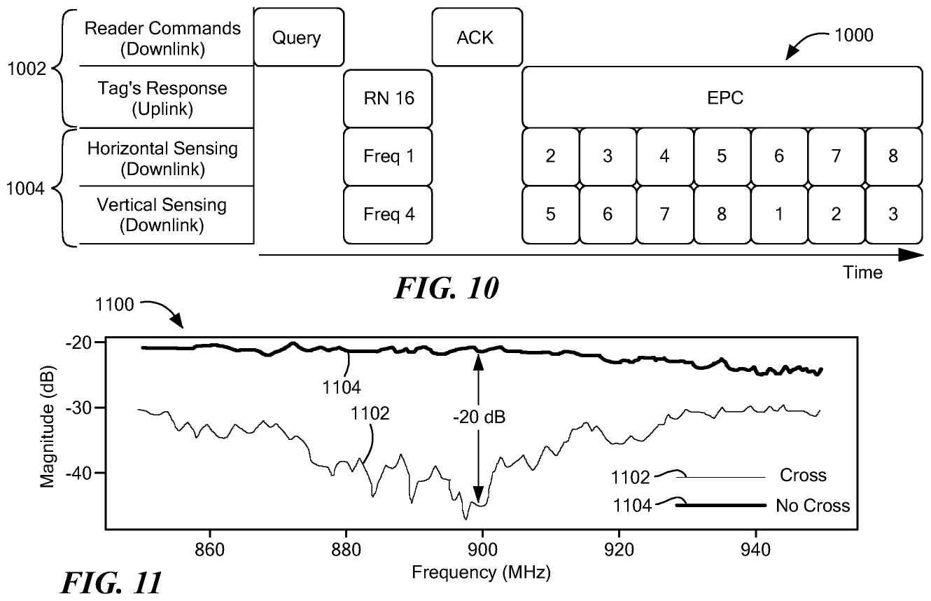

Regarding transmission, in some aspects, the RFID system may transmit the horizontal and vertical RF signals at different times, according to one aspect. However, separating the two transmit RF signals may require twice the transmission time, making it inefficient. Thus, in some aspect, the system may transmit different frequency permutations on the two transmit antennas simultaneously. For example, FIG. 10 is a timing diagram of an illustrative schedule 1000 that may be used to fit all frequencies within one round of a standard EPC Gen2 protocol. The first two rows 1002 show the RFID system's downlink commands and the target's uplink responses, respectively. During this process, the system may measure the target's channel whenever the target is backscattering (the RN16 and EPC messages). The bottom two rows 1004 show the transmitted frequencies for each of the antennas, different hashing denoting different frequencies. Since the simultaneous frequencies may be different, they do not interfere with each other and can be sent concurrently. With this, the system may measure more than 200 MHz of bandwidth for each target read, which may be sufficient for accurate localization. If the same frequency is sent on both antennas, they would result in an LP RF signal at 45°, which may cause a large polarization mismatch for targets near −45°. This may be repeated until all targets within the device's radio range are read.

For angle detection, the system may estimate the target's roll angle. To do so, the RFID localized system may leverage the fact that each antenna only receives the parallel portion of the target's reflection. Therefore, their relative channel magnitudes form a right triangle with the target's angle and can be used to estimate the target's angle. First, the system may estimate the target's channel using the target's known packet p(t) and its received RF signal γ(t) as ĥ=Σₜγ(t)p*(t), where ĥ is the estimated channel and p*(t) is the conjugate of the target's packet. Using this, the target's angle can be estimated as θ=tan⁻¹(| [symbol] /| [symbol] |)=where tan⁻¹ is the inverse tangent; [symbol] and [symbol] are channel estimates from the two antennas.

Relating to distance estimation, for each frequency, the system may combine the channel measurements from each antenna using Eq. 3, and its estimated \hat{θ}. With its UWB channel estimates, the system may invert the channel to estimate the time-of-flight to the target and measure the one-dimensional distance.

According to one aspect, the system may repeat this process for every target that it reads during discovery, which allows the system to compute the one-dimensional distance estimates for all targets in the environment accurately and efficiently.

A well-known problem in designing compact RFID readers is self-interference. Since RFID readers are full duplex (i.e., they transmit while receiving the RFID response), the transmitted RF signals may leak back to the receiver. This leakage may be stronger than the backscatter response and can overwhelm the receiver, preventing successful decoding. To deal with this leakage, RFID readers may either separate the transmitter and receiver (e.g., by half a meter) or employ a self-interference cancellation scheme. According to one aspect, the system may be preferably a compact handheld reader. Thus, separation of antennas by a large distance is impractical and a self-interference cancellation scheme may be employed.

Self-interference cancellation may face two key challenges. First, the system needs to not only cancel self-interference from an RF discovery signal, but also from the UWB out-of-band RF signal, and it is more difficult to cancel wideband RF signals (e.g., several hundred MHz) than typical narrowband RF signals. Second, the system may have two different modes for transmission that happen simultaneously: the in-band may be transmitted as a CP RF signal, and the out-of-band may be transmitted as LP RF signals. This adds further complexity, as the RFID system may need to cancel two types of RF signals that are transmitted simultaneously.

According to one aspect, the systems described herein aim to limit the self-interference from the CP RF signal used to discover the targets. To do this, the RFID system may leverage a method referred to herein as cross-polarization in the context of CP antennas. Generally, cross-polarization may mean that if a transmitter and receiver have orthogonal polarizations, then the transmitted RF signal may be significantly attenuated at the receiver. As detailed above, for example, a horizontally polarized antenna may not be able to discover a vertical target. While this phenomenon may be problematic in discovering RFID targets, the system may harness it to cancel self-interference of the in-band RF signal.

In harnessing cross-polarization, the in-band transmitted UHF RF signals may be CP. Specifically, the system may transmit with right-hand circular polarization (RHCP), i.e., the electric field travels clockwise, as depicted in FIG. 5. The cross-polarization of an RHCP transmission is left-hand circular polarization (LHCP), which rotates in the opposite direction, i.e., counter-clockwise. This ensures that the transmission and reception remain orthogonal, minimizing the received RF signal. The rotation direction, clockwise (CW) or counterclockwise (CCW), may depend on the wave propagation direction. A wave propagating in a +z direction and rotating CW has RHCP polarization. An LHCP receiver expects a CW wave in the −z direction (conjugate to its CCW in +z); if the receiver receives a CCW wave from an RHCP transmitter antenna, this results in orthogonal fields, canceling the interference between the co-located TX and RX antennas.

According to one aspect, any polarization can be described using a two-dimensional complex vector [Eₕ, Eᵥ], where the coordinates correspond to the horizontal and vertical (complex) numbers applied to the transmitted vector. An RHCP polarization can be realized as E_{RHCP}=1/\sqrt{2}[1, e^{-jπ/2}] where 1/\sqrt{2} is the power normalization factor. An LHCP can be realized as E_{LHCP}=1/\sqrt{2}[1,e^{+jπ/2}]. Since the received RF signal is a projection of the transmitted polarization on the received polarization, the resulting RF signal preferably may be:

$$〈 {E}_{RHCP} , {E}_{LHCP}^{*} 〉 = \frac{1}{\sqrt{2}} [ 1 , {e}^{- j π / 2} ] * \frac{1}{\sqrt{2}} [ \begin{matrix}1 \\ {e}^{- j π / 2}\end{matrix} ] = 0 \qquad ( 4 )$$

To implement LHCP at the receiver using two LP antennas, the system may use a method similar to generating an RHCP RF transmit signal. For example, as detailed above, the system may implement RHCP by adding a −90° phase shift between the two transmitted RF signals. Similarly, the system may add a +90° phase between the two RF receive signals to create an LHCP at the receiver.

The impact of the cross-polarization mechanism on cancelling the leakage can be shown, according to one aspect, by measuring the isolation (i.e., attenuation of the leakage) between the transmitter and receiver. For example, the system may be placed in a large, open space with RF absorbers on the floor and covering all equipment (to mitigate the impact of reflections off the surrounding environment). Using a vector network analyzer, the isolation between the transmitter and receiver may be measured from 850 MHz to 950 MHz (the ISM band). FIG. 11 is a plot 1100 showing the isolation with (1102) and without (1104) the cross polarization as a function of frequency. When receiving without cross polarization at 900 MHZ, the system may only achieve about 21 dB of isolation. This natural isolation may be due to the antenna spacing. In comparison, the system when implementing cross-polarization may achieve about 45 dB of isolation, an improvement more than 20 dB (i.e., over a factor of 100×).

According to aspects of the disclosure, once the RF signal backscatters, it may become LP, indicating that cross-polarization mitigates may self-interference, but it also does not attenuate the received backscatter response. A CP antenna can receive an LP RF signal, regardless of its polarization. This can be seen when considering the polarization projections. If a target's polarization is E_{tag}=[cos θ, sin θ], the amplitude of the RF signal received by the target may be:

$$〈 {E}_{RHCP} , {E}_{tag}^{*} 〉 = \frac{1}{\sqrt{2}} [ 1 , {e}^{- j π / 2} ] * [ \begin{matrix}cos θ \\ sin θ\end{matrix} ] = \frac{1}{\sqrt{2}} ( cos ( θ ) ) + {e}^{- j π / 2} sin ( θ ) \qquad ( 5 )$$

This RF signal may be backscattered by the target, which can be modeled as re-emitting the received RF signal along the same polarization. Since the propagation direction is reverse, the RF signal is emitted at −θ. Hence, the polarization of the received RF signal can be expressed as:

$$〈 {E}_{tag} , {E}_{LHCP}^{*} 〉 = \frac{1}{\sqrt{2}} [ cos ( - θ ) , sin ( - θ ) ] * [ \begin{matrix}1 \\ {e}^{- j π / 2}\end{matrix} ] = \frac{1}{\sqrt{2}} ( cos ( - θ ) ) + {e}^{- j π / 2} sin ( - θ ) \qquad ( 6 )$$

Here, the amplitude and phase of backscatter may be ignored as these are simply scalars from the perspective of polarization. The above shows that even though the system's RF transmit and receive signals may be circularly cross-polarized, they are able to receive an LP RF backscatter signal.

According to one aspect, cross-polarization may yield an orientation-agnostic phase estimate in the system's overall design. Indeed, the round-trip channel may be a product of Eq. 5 and Eq. 6 may be ½ (a real number with no phase offset). However, the system's overall CCP-based approach may provide advantages to using cross-polarized antennas for at least two reasons. First, CP antennas may suffer from a polarization degradation of about −6 dB, which may lead to a lower SNR than the RFID system, and thus lower accuracy and range. Second, while the above formulation may work for narrowband ISM signals, it becomes more challenging in wideband RFID localization. This is because CP RFID reader antennas become elliptically polarized as we move away from their center frequency. Mathematically, this induces a phase offset Φ(f) other than π/2 in the antennas, and the end-to-end channel may become cos²(θ)−e^{-j2Φ(f)} sin²(θ), making it orientation-dependent and precluding the system from using it for phase-based localization.

In addition to the CP RF signals, the RFID system may need to minimize the self-interference from the LP RF signals used for localization. Unlike for the in-band CP RF signal, applying a self-interference cancellation mechanism similar to the cross-polarization to the out-of-band LP RF signals may be problematic. While a cross-polarized receive antenna (e.g., a horizontal receive antenna for a vertical transmit antenna) would attenuate the leakage, this may also significantly attenuate the target's response. For example, considering a vertical target, when transmitting on a vertical antenna, the target's backscatter response may be strong. However, a horizontal antenna cannot receive its response due to the polarization mismatch (as detailed above). Similarly, when transmitting on the horizontal antenna, the reflected RF signal may be weak due to polarization mismatch. In this case, the system may be unable to measure the target response from either antenna pair. Thus, parallel transmit and receive antennas are used, leading to high leakage.

To overcome this, the RFID system may, according to one aspect, employ over-the-wire nulling, using MIMO interference cancellation. Generally, such a method may estimate the leakage signal and inject another RF signal into the receiver, structuring it so that destructively combines with the leakage at the receiver. The RFID system may repeat this process for each frequency for wideband nulling and perform it independently for the vertical and horizontal antenna pairs.

The impact of nulling may be investigated by measuring the cancellation between the parallel antennas. According to one aspect, a fixed RF signal may be transmitted and compared the magnitude of leakage with and without nulling.

TABLE 1

| | Frequency (MHz) | | | | | | | | |
|---|---|---|---|---|---|---|---|---|---|
| | 763 | 790 | 817 | 844 | 871 | 952 | 979 | 1006 | Avg |
| Vert | 20.5 | 23.8 | 26.5 | 21.2 | 24.5 | 22.1 | 25.9 | 21.2 | 23.2 |
| Horiz | 25.6 | 21.4 | 24 | 20.8 | 30.5 | 18.9 | 31.4 | 16.2 | 23.6 |

Table 1 reports the average cancellation from nulling for the vertical and horizontal pairs of antennas, according to one aspect. The table shows the cancellation for each frequency, and the average cancellation across frequencies. With an average cancellation of 23 dB, the RFID system may mitigate the self-interference between parallel antennas. This is the cancellation on top of the natural isolation of the antennas (due to the attenuation of the RF signal over the direct path). With a natural isolation of ˜20 dB (achievable by either small antenna spacing or a circulator), the overall isolation is >40 dB, roughly equivalent to that of the cross-polarized in-band RF signal.

According to one aspect of the disclosure, an RFID system may collect one-dimensional measurements across space to perform three-dimensional localization via trilateration. One challenge in performing three-dimensional localization is selecting more optimal vantage points for localization. Specifically, if the measurements are collected from nearby locations, their intersection may be sensitive to small errors in the one-dimensional estimates. This is a known phenomenon in RF localization systems called dilution of precision (DoP). Accordingly, the system may need to choose measurement locations that are furthest apart to reduce the probability of a poor DoP.

To accomplish this, according to one aspect, the RFID system may implement an algorithm that intelligently selects a subset of its one-dimensional measurements to use for trilateration. The goal of the selection may be to maximize DoP and measurement SNR (in order to minimize the likelihood of erroneous measurements for each target and thus improve the robustness of localization). According to one aspect, the RFID system's measurement selection algorithm may include filtering the measurements, sorting the measurements, and selecting the measurements for trilateration. The first step may involve filtering to remove all measurements with an SNR below a threshold (e.g., ˜4 dB). This helps eliminate poor measurements that are likely to have high error. The second step may involve sorting all measurements for a given target based on their location in space and dividing the bounding box that contains them into 3×3×3 evenly spaced grid. The final step may be selecting the measurement with the highest SNR from each grid. If a grid space is empty, the measurement with the highest SNR may be selected.

After selecting one-dimensional measurements, the RFID system may perform trilateration with outlier rejection to localize in three-dimensions. This may be repeated for every target in the environment.

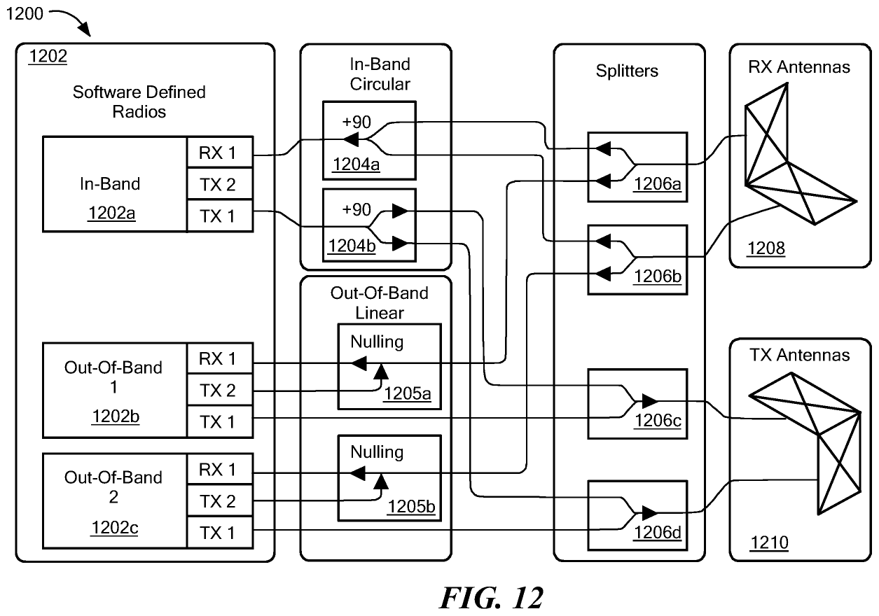

Turning now to FIG. 12, a RFID system's architecture 1200 is shown, according to one aspect of the disclosure, implemented in a wideband RFID system. The system may include three Nuand BladeRF software defined radios 1202: one for the CP RF signal 1202a, one for the horizontal LP RF sensing signal 1202b and one for the vertical linearly RF polarized signal 1202c. To create a CP RF signal, the RFID system may include two ZX10Q-2-13-S+ RF power splitters 1204a, 1204b to apply 90° phase shifts. At each antenna (receive antennas 1208 and transmit antennas 1210), the RF signals for the CP RF signals and LP RF signals may be combined (or split) using ZAPD-21-S+ splitters 1206a-d. The out-of-band LP RF signals may undergo nulling 1205a, 1205b, as detailed above, for interference cancellation.

According to one aspect, the RFID system may include custom-designed antennas 1208, 1210 to have a small factor and desired frequency range (700 MHz to 1 GHz). A bowtie design may be implemented due to its ability to achieve relatively flat wideband operation in small form factor. The antennas may be fabricated, for example, on a 0.8 mm-thick FR4 substrate and measure 4.5 cm×11 cm. Since the bowtie antenna may be a balanced structure, balun (balanced to unbalanced component) may be added between its two branches to efficiently connect it to a coaxial cable (an unbalanced structure).

According to one aspect, the software defined radios may be coupled to a Raspberry Pi computer to collect RFID measurements. Self-localization may be implemented using an Intel Realsense T265 camera, which has a built-in visual-inertial odometry (VIO). The output of the camera may be synchronized with the samples obtained from the software defined radios. The measurements may be processed, and the three-dimensional location estimates may be computed on an Ubuntu 20.04 computer. The SciPy library may be used to perform trilateration.

While the above architecture implements a number of named components, one skilled in the art will recognize that the disclosed aspects herein are not limited to those particular processing components and may be implemented using a variety of hardware, software, firmware in combination to achieve the disclosed system.

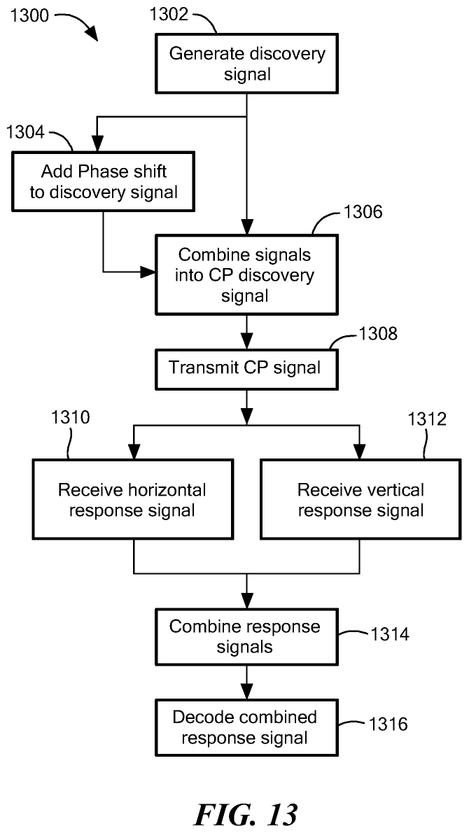

Turning now to FIG. 13 is a flow diagram of an illustrative method 1300 of discovering an RFID target, according to aspects of an RFID system described herein. As shown in block 1302, the RFID system may generate an RF discovery signal. The RF discovery signal may be transmitted to both a first LP antenna and, as shown in block 1304, a phase shifter where a phase offset, for example 90°, may be added to the RF discovery signal. The phase-shifted RF signal may be transmitted to a second LP antenna. As shown in block 1306, the RFID system may combine the two LP RF signals via vector addition into a single CP (CP) RF signal.

As shown in block 1308, the RFID system may transmit the CP RF signal into the environment to discover and identify an RFID target. A target receiving the incident CP RF signal may be powered up by the CP RF signal and may backscatter or otherwise reflect the RF signal, carrying target identification information, in the form of a first response RF signal (horizontal) and a second response RF signal (vertical). The horizontal and vertical response RF signals may be LP. As shown in blocks 1310 and 1312, the RFID system may receive the horizontal and vertical RF response signals. The RFID system may combine the LP RF response signals to generate a CP RF response signal, as shown in block 1314. The RFID system may then decode the CP RF response signal, as shown in block 1316, to determine target identification information or the like. According to one aspect, the RFID target has now been discovered and powered and the RFID system may localize the target.

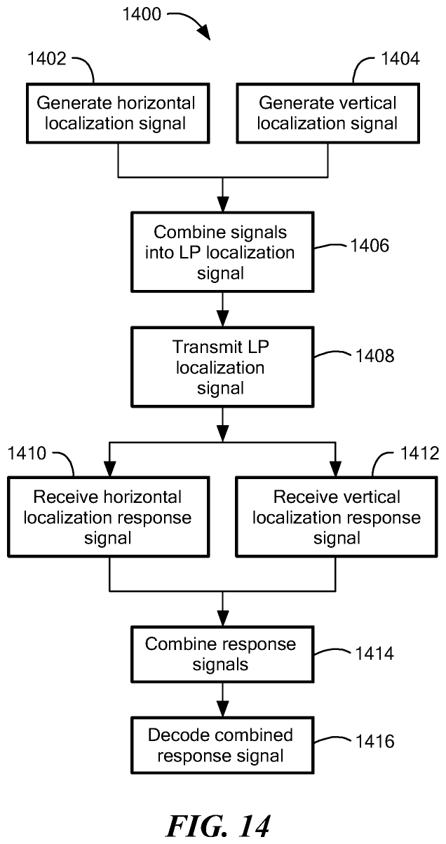

FIG. 14 is a flow diagram of an illustrative method 1400 to localize an RFID target, according to aspects of the disclosure described herein. The RFID system may be configured to generate and receive an LP RF signal whose orientation matches the orientation of the RFID target. As shown in blocks 1402 and 1404, the RFID system may begin a localization operation by generating two orthogonal, LP RF signals, one from a horizontal antenna and another from a vertical antenna. As shown in block 1406, the RFID system may combine the two orthogonal RF signals into a single, LP RF signal at an angle. According to one aspect, the RFID system may independently control the amplitudes of each RF signal to generate an LP RF signal at a desired angle, such as the orientation angle of the target. The RFID system may transmit the RF localization signal to a previously powered and identified target, shown in block 1408. As shown in block 1410 and 1412, the RFID system may receive backscattered RF response signals to the horizontal antenna and the vertical antenna, respectively. Each antenna may receive only the component of the target's response that is parallel to its polarization. As shown in block 1414, the RFID system may combine the two RF response signals from each antenna in a similar manner to the transmitted LP RF signal. Combining the RF signals may result in optimizing the power of the received RF signal, maximizing the SNR and allowing for greater accuracy and distance of the localization operation. The combined LP RF response signal may be decoded, as shown in block 1416, to determine localization information, including but not limited to, one-dimensional and three-dimensional localization information.

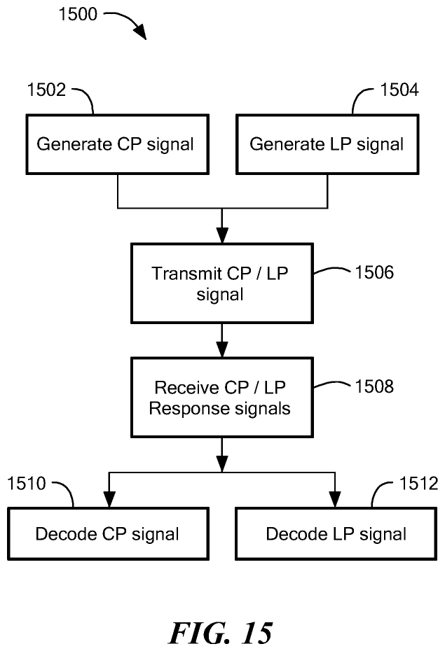

The RFID system may be configured to jointly discover (i.e., power) and localize an RFID target simultaneously. FIG. 15 is a flow diagram of a method 1500 of jointly discovering and localizing an RFID target, according to aspects of the disclosure. As described herein and shown in block 1502, the RFID system may generate a CP (CP) RF signal for discovering an RFID target. The RFID system may also, as described herein, generate an LP (LP) RF signal for localization of the target, shown in block 1504. The RFID system may transmit the CP RF discovery signal and the LP RF localization signal substantially concurrently, as shown in block 1506. As detailed above, the CP and LP RF signals may be transmitted at different frequencies from the same antennas without the RF signals impacting each other's polarizations.

As shown in block 1508, the RFID system may receive CP and LP RF response signals from the RFID target, as shown in blocks 1510 and 1512, where each RF signal may be decoded to provide discovery information and localization information, respectively. Accordingly, the RFID system may be configured to discover and localize an RFID target simultaneously without additional overhead and regardless of the target's orientation.

While the systems and methods described herein relate to a handheld RFID discovery and localization system, one skilled in the art will recognize the techniques disclosed herein may be applicable to stationary systems which may benefit from increased read rate and target SNR.

Although reference is made herein to particular materials, it is appreciated that other materials having similar functional and/or structural properties may be substituted where appropriate, and that a person having ordinary skill in the art would understand how to select such materials and incorporate them into embodiments of the concepts, techniques, and structures set forth herein without deviating from the scope of those teachings.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value. The term “substantially equal” may be used to refer to values that are within +20% of one another in some embodiments, within +10% of one another in some embodiments, within +5% of one another in some embodiments, and yet within +2% of one another in some embodiments.

The term “substantially” may be used to refer to values that are within +20% of a comparative measure in some embodiments, within +10% in some embodiments, within +5% in some embodiments, and yet within +2% in some embodiments. For example, a first direction that is “substantially” perpendicular or orthogonal to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

What is claimed is:

1. A method of discovering a radio frequency identification (RFID) target, the method comprising:
generating a first radio frequency (RF) signal from a first linearly polarized (LP) antenna;
generating a second RF signal from a second LP antenna, with the first and second RF signals having a relative phase shift therebetween;
transmitting the first RF signal from the first LP antenna; and
transmitting the second RF signal from the second LP antenna;
wherein transmission of the first RF signal and the second RF signal generate an RF discovery signal.

2. The method of claim 1 wherein the first and second LP antennas are orthogonal.

3. The method of claim 1 wherein the RF discovery signal provides a power source to the RFID target.

4. The method of claim 1 wherein the RF discovery signal is a vector addition of the first and second RF signals.

5. The method of claim 1 wherein the phase and amplitude of the first RF signal are independently controlled from the phase and amplitude of the second RF signal, respectively.

6. The method of claim 1 further comprising receiving a first RF response signal and a second RF response signal from the target.

7. The method of claim 6 further comprising generating an RF discovery response signal by combining the first RF response signal and the second RF response signal with a 90-degree phase shift.

8. The method of claim 7 further comprising decoding the RF discovery response signal into RFID target identification information.

9. The method of claim 1 wherein the RF discovery signal is transmitted substantially concurrently with an RF localization signal.

10. A method of localizing a radio frequency identification (RFID) target, the method comprising:
generating a first radio frequency (RF) signal from a first linearly polarized (LP) antenna;
generating a second RF signal from a second LP antenna, with the first and second RF signals having the same phase;
transmitting the first RF signal from the first LP antenna; and
transmitting the second RF signal from the second LP antenna;
wherein concurrent transmission of the first RF signal and the second RF signal generate an RF localization signal.

11. The method of claim 10 wherein the RF localization signal is an LP RF signal at an angle, the angle representative of an orientation of the RFID target relative to the first or second LP antenna.

12. The method of claim 10 wherein the RF localization signal is transmitted substantially concurrently with an RF discovery signal.

13. The method of claim 12 wherein the RF discovery signal and the RF localization signals are transmitted at different frequencies.

14. A system for localizing a radio frequency identification (RFID) target, the system comprising:
a mobile device including one or more sensors configured to determine a first location of the mobile device in an environment;
an RFID system coupled to the mobile device and configured to receive a radio frequency (RF) signal from the RFID target; and
a processor coupled to the RFID system configured to locate the RFID target based on the RF signal and the first location.

15. The system of claim 14 wherein the mobile device includes a camera.

16. The system of claim 15 wherein the one or more sensors comprise one of an inertial measurement unit, an accelerometer, or a gyroscope.

17. The system of claim 14 wherein the mobile device is further configured to determine a second location of the mobile device, and wherein the processor is further configured to locate the RFID target based on the first location, the second location, and the RF signal.

18. The system of claim 14 wherein the processor is configured to locate the RFID target based on a plurality of RF signals from a plurality of RFID targets.

19. The system of claim 18 wherein the plurality of RF signals are combined in a voting mechanism to locate the RFID target.

20. The system of claim 14 wherein the mobile device is further configured to determine the first location based on the RF signal.
